(19) United States
(12) Patent Application Publication
(10) Pub. No.: US 2008/0278052 A1
(43) Pub. Date: Nov. 13, 2008

(54) Filter and display apparatus having the same

(76) Inventor: Cha-Won Hwang, Suwon-si (KR)

Correspondence Address: ROBERT E. BUSHNELL, 1522 K STREET NW, SUITE 300, WASHINGTON, DC, 20005-1202, US

(21) Appl. No.: 12/149,676

(22) Filed: May 6, 2008

(30) Foreign Application Priority Data
May 10, 2007 (KR) 10-2007-0045367
Mar. 27, 2008 (KR) 10-2008-0028493

(51) Int. Cl. H01J 61/40; H01K 1/26; G02B 1/10; G02B 1/11

(52) U.S. Cl. 313/112; 359/580; 359/585; 359/586

(57) ABSTRACT

A filter that has an excellent light room contrast, reduced double image formation, reduced external light reflection, lightweight, slim, inexpensive to produce, and a display apparatus having the filter. The filter made out of one sheet includes a reflection preventing layer arranged as the outermost layer of the filter, an electromagnetic wave shielding layer arranged on a rear surface of the reflection preventing layer and a base film arranged on a rear surface of the electromagnetic wave shielding layer.

### CLAIM OF PRIORITY

This application claims the benefit of Korean Patent Application Nos. 10-2007-0045367, filed on May 10, 2007, and 10-2008-0028493, filed on March 27, 2008, in the Korean Intellectual Property Office, the disclosures of which are incorporated herein in their entireties by reference.

### BACKGROUND OF THE INVENTION

1. Field of the Invention

The present invention relates to a filter and a display apparatus having the filter, and more particularly, to a filter for a display that has an excellent light room contrast, is slim and lightweight, prevents the formation of a double image, reduces external light reflection and is inexpensive to produce.

2. Description of the Related Art

A plasma display apparatus, using a plasma display panel (PDP), is a flat panel display apparatus that displays an image by using gas discharge, and is expected to become one of the next generation of large flat panel display devices due to its excellent display characteristics, such as high brightness and contrast, resistance to residual image, large viewing angle, slimness, and large screen size, as compared to a conventional cathode ray tube (CRT).

However, a plasma display apparatus gives a double reflection of an image, due to refraction caused by a material difference between a front substrate of a plasma display panel and a tempered glass filter. Also, the tempered glass filter must have a thickness of approximately 3 mm or more to resist external impact, thereby increasing weight and cost. Furthermore, a tempered glass filter has a very complicated structure that includes various filters having various functions. Therefore, the process of manufacturing the tempered glass filter is complicated and costly.

### SUMMARY OF THE INVENTION

The present invention provides a filter that can prevent a double image from forming, increases light room contrast, is slimmer than earlier filters, has a reduced weight, and a display apparatus having the filter.

The present invention also provides a filter that has low manufacturing cost and is easy to manufacture, and a display apparatus having the filter.

According to an aspect of the present invention, there is provided a filter that includes, a base film an electromagnetic wave shielding layer arranged on a top surface of the base film and a reflection preventing layer arranged on a top surface of the electromagnetic wave shielding layer, the reflection preventing layer being a top layer of the filter, the filter being of only one sheet.

The reflection preventing layer can include a surface hardness enhancing layer that includes a hard coating material, the reflection preventing layer can be of a single layer. The reflection preventing layer can be an anti-reflection layer that includes a plurality of thin film layers stacked on top of each other, a top layer of the plurality of thin film layers having a refractive index that is less than a one of the plurality of thin film layers arranged underneath and contacting the top layer. The reflection preventing layer can include an anti-glare layer having a predetermined curve arranged on a top surface thereof. The reflection preventing layer can also include a hard coating layer arranged on the anti-glare layer. A thickness of the reflection preventing layer can be in the range of 5.0 to 12.0 μm, a pencil hardness of the reflection preventing layer can be in the range of 1 H to 3 H, and a haze of the reflection preventing layer can be in the range of 1% to 10%.

The electromagnetic wave shielding layer can include at least one metal layer or at least one metal oxide layer. The electromagnetic wave shielding layer can include a patterned silver print layer and a Cu-coating film arranged on the patterned silver print layer. The patterned silver print layer can include one of AgCl and AgNO₃. The patterned silver print layer can be of a mesh shape. A combined thickness of the patterned silver print layer and the Cu coating film can be in the range of 2 to 6 μm. The patterned silver print layer can be produced by a photo etching process. The patterned silver print layer can be produced by a process that includes coating a photosensitive resin layer on the base film and performing a printing process on the photosensitive resin layer.

The base film can include one of polyethersulphone, polyacrylate, polyetherimide, polyethyelenen napthalate, polyethyeleneterepthalate (PET), polyphenylene sulfide, polyallylate, polyimide, polycarbonate, cellulous triacetate, cellulose acetate propinonate and a combination thereof. A light transmittance with respect to visible light of the filter can be in the range of 20% to 90%, and a haze can be in the range of 1% to 15%.

According to another aspect of the present invention, there is provided a display apparatus that includes the filter as described above on a front surface of the display apparatus. A light transmittance with respect to visible light of the filter can be in the range of 20% to 90%, and an entire haze can be in the range of 1% to 15%. The display can also include an adhesive layer arranged on a rear side of the base film, the adhesive layer to adhere the filter to the front surface of the display apparatus. The adhesive layer can include one of acrylic resin, polyester resin, epoxy resin, urethane resin, and pressure sensitive adhesive (PSA). The adhesive layer can include at least one of a dye and a pigment to perform color correction, neon glow blocking, or near infrared ray blocking.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic cross-sectional view illustrating the configuration of a filter according to an embodiment of the present invention;

FIG. 2 is a schematic cross-sectional view illustrating an example of the configuration of a reflection preventing layer of the filter of FIG. 1, according to an embodiment of the present invention;

FIG. 3 is a schematic cross-sectional view illustrating another example of the configuration of the reflection preventing layer of the filter of FIG. 1, according to another embodiment of the present invention;

FIG. 4 is a schematic cross-sectional view illustrating another example of the configuration of the reflection preventing layer of the filter of FIG. 1, according to another embodiment of the present invention;

FIGS. 5A through 6 illustrate a method of manufacturing a electromagnetic wave shielding layer of the filter of FIG. 1 by using an etching technique;

FIGS. 7A through 8 illustrate a method of producing the electromagnetic wave shielding layer of the filter of FIG. 1 by using exposing and coating techniques, according to an embodiment of the present invention;

FIGS. 9A through 10 illustrate a method of producing the electromagnetic wave shielding layer of FIG. 1 by using a printing technique, according to an embodiment of the present invention;

FIG. 11 is an exploded perspective view of a plasma display apparatus having the filter of FIG. 1, according to an embodiment of the present invention; and

FIG. 12 is a cross-sectional view taken along line XII-XII of FIG. 11.

### DETAILED DESCRIPTION OF THE INVENTION

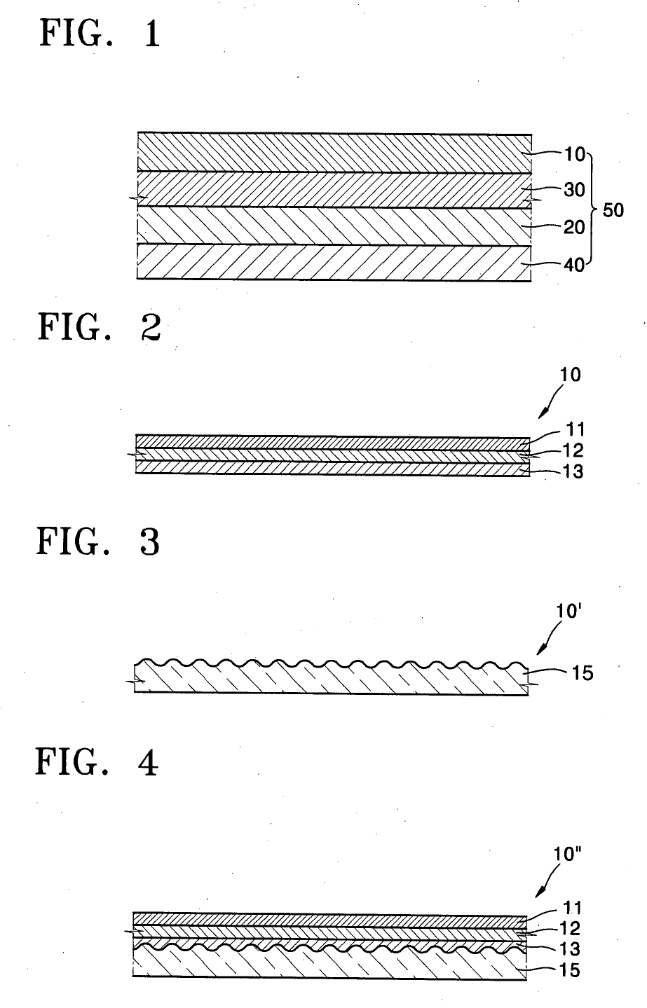

Referring now to FIG. 1, FIG. 1 is a schematic cross-sectional view illustrating the configuration of a filter 50 according to an embodiment of the present invention. Referring to FIG. 1, the filter 50 according to an embodiment of the present invention is formed as one sheet that includes a reflection preventing layer 10 arranged as an outermost layer of the filter 50, an electromagnetic wave shielding layer 30 arranged on a rear side of the reflection preventing layer 10, a base film 20 arranged on a rear side of the electromagnetic wave shielding layer 30, and an adhesive layer 40 arranged on a rear side of the base film 20 so as to adhere the filter 50 to a front side of a plasma display apparatus. A “multi-sheet type filter” has two or more functional films selected from a group of functional films including an anti-reflection film, an anti-glare film and an EMI film. Each functional film has a base film and a functional layer formed on the base film, and one functional film is bound to another functional film by an adhesive layer. However, a “one-sheet type filter” according to the present invention includes only one base film and two or more functional layers are formed on the base film.

In FIG. 1, the reflection preventing layer 10 prevents deterioration of light room contrast of the filter 50 due to reflection of external light incident onto a front side of the filter 50. The reflection preventing layer 10 can include a single surface hardness enhancing layer, an anti-reflection layer, and/or an anti-glare layer. The reflection preventing layer 10 can be made to have a thickness in the range of 5.0 to 12.0 μm. A pencil hardness of the reflection preventing layer 10 can be in the range of 1 to 3H, and haze of the reflection preventing layer 10 can be in the range of 1 to 10%.

The electromagnetic wave shielding layer 30 shields electromagnetic waves that are harmful to the human body and are generated within the display apparatus. The electromagnetic wave shielding layer 30 can consist of a conductive layer (not shown). That is, the electromagnetic wave shielding layer 30 can be formed by stacking one or more metal layers and/or metal oxide layers, or can be formed as a multi-layered structure of three layers to eleven layers. In particular, when a metal oxide layer and a metal layer are stacked together, the metal oxide layer can prevent the metal layer from oxidizing or deteriorating. Also, if the electromagnetic wave shielding layer 30 is a multi-layered structure, a surface resistance value of the electromagnetic wave shielding layer 30 can be revised and the transmittance of visible light can be controlled.

The metal layer can be made out of palladium (Pd), copper (Cu), gold (Au), platinum, rhodium (Rh), steel (Fe), cobalt (Co), nickel (Ni), zinc (Zn), ruthenium (Ru), tin (Sn), tungsten (W), iridium (Ir), lead (Pb), silver (Ag), or a combination thereof. The metal oxide layer can be made out of tin oxide, indium oxide, antimony oxide, zinc oxide, zirconium oxide, titanium dioxide, magnesium oxide, silicon oxide, aluminum oxide, metal alkoxide, indium-tin-oxide (ITO), antimony-tin-oxide (ATO), or the like. The electromagnetic wave shielding layer 30 can be produced on base film 20 by a sputtering technique, a vacuum evaporation technique, an ion plating technique, a chemical vapor deposition (CVD) technique, a physical vapor deposition (PVD) technique, or the like.

The metal layer or the metal oxide layer has a near infrared ray blocking function as well as an electromagnetic wave blocking function. Accordingly, the malfunction of peripheral electronic devices due to near infrared rays produced within the display can be reduced.

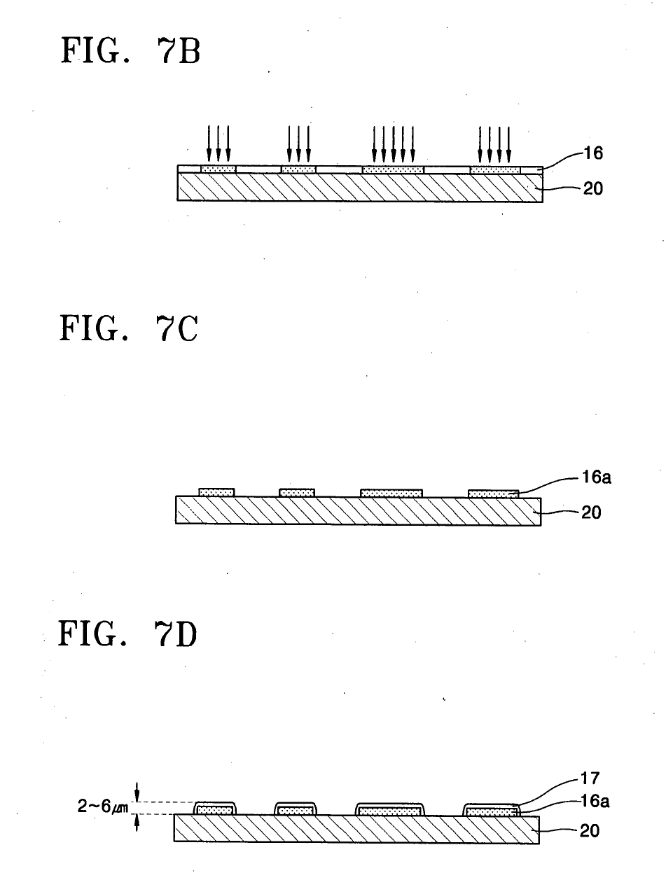

The electromagnetic wave shielding layer 30 is not limited to the above shape, but can be formed in a mesh shape using a conductive metal (for example, Cu). A method of forming the electromagnetic wave shielding layer 30 on the base film 20, such that the electromagnetic wave shielding layer 30 is in a mesh shape, will be described later in detail with reference to FIGS. 5A through 10.

Details of the base film 20 will now be described. The base film 20 can be made out of a material that can transmit visible light, and can be made out of a flexible material for convenience of transportation and adherence. The base film 20 can be made out of one of polyethersulphone (PES), polyacrylate (PAR), polyetherimide (PEI), polyethyelenen napthalate (PEN), polyethyeleneterepthalate (PET), polyphenylene sulfide (PPS), polyallylate, polyimide, polycarbonate (PC), cellulose triacetate (TAC), cellulose acetate propinonate (CAP), or a combination thereof, and preferably, can be made out of one of PC, PET, TAC and PEN.

The base film 20 can be made to have a predetermined color to control the transmittance of visible light through the filter 50. For example, when the base film 20 has a dark color, the transmittance of visible light is reduced. Furthermore, the color of light transmitted through the filter 50 can be controlled by the base film 20. That is, the whole base film 20 can be colored to give a pleasant appearance to the user, or can be colored to increase the chroma of the display apparatus that employs the filter 50 according to an embodiment of the present invention. Also, the color of the base film 20 can be patterned to correspond to each sub-pixel of the plasma display panel that employs the filter 50 according to an embodiment of the present invention. However, the present invention is not limited thereto, and the base film 20 can be colored in various ways for a variety of color correction purposes.

The base film 20 has a flat panel shape, and can have a thickness of 50 to 500 μm. However, as the thickness of the base film 20 is reduced, the scattering prevention effect of a plasma display panel is reduced, and as the thickness of the base film 20 is increased, the efficiency of a laminating process is reduced. Therefore, the base film 20 preferably has a thickness in the range of 80 to 400 μm.

The adhesive layer 40 adheres the filter 50 to the front surface of the display apparatus. A refractive index difference between the adhesive layer 40 and the plasma display panel can not exceed a predetermined value, for example, 1.0%, in order to prevent a double image from occurring. The adhesive layer 40 can include thermoplastics, or an ultraviolet (UV) hardening resin, such as acrylic resin, polyester resin, epoxy resin, urethane resin or pressure sensitive adhesive (PSA). The adhesive layer 40 can be produced by dip coating, air knife coating, roller coating, wire bar coating, gravure coating, etc.

The adhesive layer 40 can further include a compound that absorbs near infrared rays. The compound can be a resin that includes copper atoms, a resin that includes a copper compound or a phosphorus compound, a resin that includes a copper compound or a THIO urea derivative, a resin that includes a tungsten compound, or a cyanine compound.

The adhesive layer 40 can further include a dye or a pigment to provide color correction by blocking neon glow. The dye or pigment selectively absorbs visible light having a wavelength of 400 to 700 nm. In particular, when discharge occurs in the plasma display panel, undesirable visible light having a wavelength of approximately 585 nm is generated by neon discharge gas. To absorb this light, a pigment compound of cyanine, squaryl, azomethine, xanthine, oxonol, or azo group can be used such that the pigment compound is dispersed in a fine grain state throughout the adhesive layer 40.

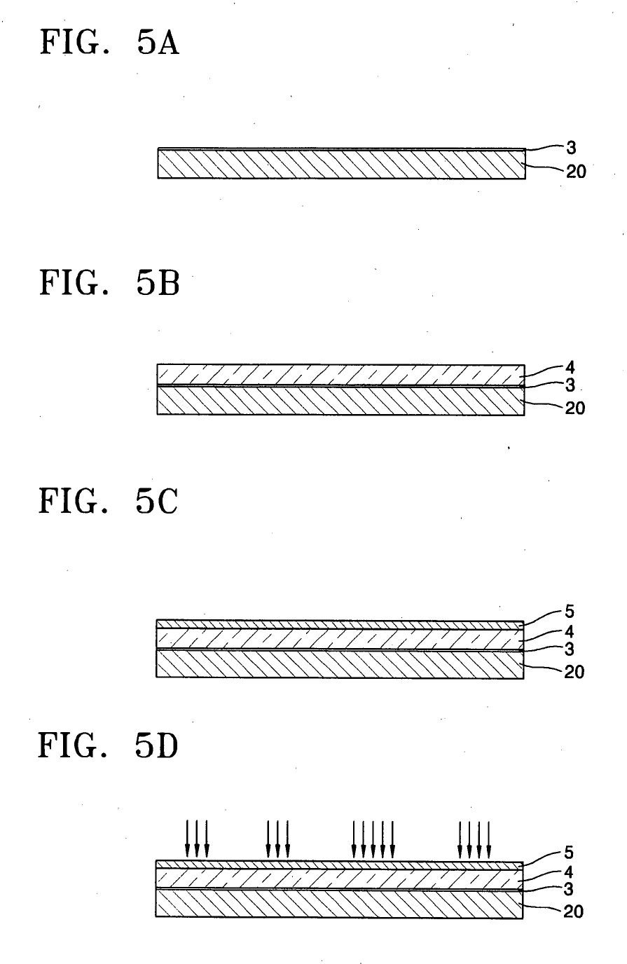

The configuration of the reflection preventing layer 10 of the filter 50 of FIG. 1 will now be more fully described with reference to FIGS. 2 through 4. FIGS. 2 through 4 are cross-sectional views the reflection preventing layer 10 according to other embodiments of the present invention. Referring to FIG. 2, the reflection preventing layer 10 can be made out of a material that has transmittance with respect to visible light, and can be formed as a multi-layer structure having two or more layers having different refractive indexes. Here, a refractive index of a first layer 11 formed as the outermost layer is less than that of a second layer 12 contacting the first layer 11. Also, a thickness of the first layer 11 is controlled so that light reflected from a surface of the first layer 11 and light reflected from a surface of the second layer 12 offset each other.

For example, the following formula 1 is obtained by calculating a path difference between light incident on a front surface of a display apparatus and reflected from a surface of the first layer 11 and light that is refracted from a surface of the first layer 11 and passes through the second layer 12 and then is reflected from a front surface of the electromagnetic wave shielding layer 30 arranged on a rear side of the third layer 13 of the anti-reflection layer 10.

$$δ = \frac{2 π}{λ} {n}_{1} {d}_{1} cos θ \pm ψ \qquad [ formula 1 ]$$

Here, δ is a path difference value in radian units, λ is a wavelength of incident light, n₁ is refractive index of the first layer 11, d₁ is a thickness of the first layer 11, θ is an incidence angle of incident light, and ψ is a consideration value of reflection phase shift.

In the formula 1, if ψ is assumed to be 0, when both formula 2 and formula 3 are satisfied, the reflectivity is the least and destructive interference occurs.

$$R = \frac{{( {n}_{1}^{2} - {n}_{0} {n}_{2} )}^{2}}{{( {n}_{1}^{2} + {n}_{0} {n}_{2} )}^{2}} \qquad [ formula 2 ]$$

Here, R is reflectivity, n₀ is refractive index of air, and n₂ is refractive index of the second layer 12.

$${d}_{1} = \frac{λ}{4 {n}_{1}} \qquad [ formula 3 ]$$

Accordingly, a designer determines n₁ so that R has a value as close as possible to 0 according to formula 4 that is a varied form of formula 2. If the numerator in formula 2 is set to zero, n₁ would satisfy formula 4.

n₁=\sqrt{n₀n₂} [formula 4]

As described above, after determining n₁, a material having a refractive index that is close to the n₁ value is selected as a material of forming the first layer 11. Then, a thickness d₁ of the first layer 11 is determined by substituting the n₁ value and a center wavelength value (λ=550 nm) of visible light into formula 3. Not only can the refractive index n₁ of first layer 11 of which a reflectivity R becomes the least and the material of forming the first layer 11 be determined, but also the thickness d₁ of the first layer 11 can be determined by using the above method.

In the above calculation, the center wavelength value of the visible light is used to determine the thickness d₁ of the first layer 11. However, the present invention is not limited thereto. The designer can substitute a wavelength value of visible light of a band as required, so that the thickness d₁ of the first layer 11 can be determined. It is to be understood that the thickness of the reflection preventing layer 10 of FIG. 2 is almost entirely based on a thickness of the third layer 13 as the thicknesses of the first layer 11 and the second layer 12 can be one-tenth of the thickness of the third layer 13.

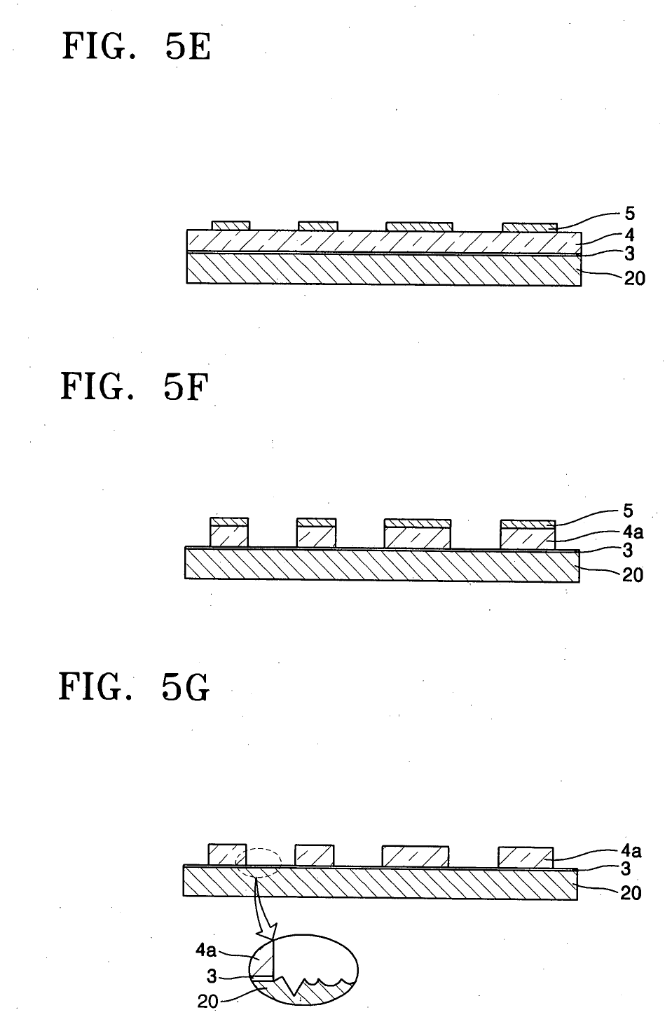

Referring now to FIG. 3, the reflection preventing layer 10′ can be formed to have an anti-glare layer 15 having a predetermined curves on its top surface. Here, incident light is diffused, reflected and dispersed, and the amount of reflected light incident to the eyes of a user who stares at a front side of a display apparatus can be dramatically reduced. A hard coating layer (not shown) can be further formed on a surface of the anti-glare layer 15.

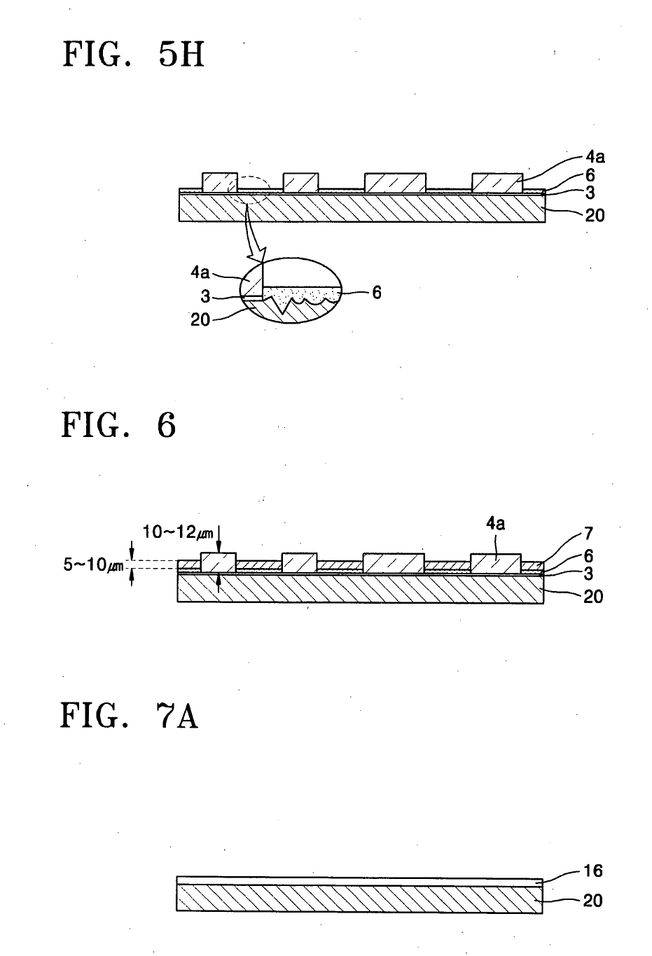

Referring to FIG. 4, the reflection preventing layer 10″ can be a compound layer of the reflection preventing layers 10 and 10′ of FIGS. 2 and 3. The reflection preventing layer 10″ can be formed in a shape in which the anti-glare layer 15 is attached to a rear surface of the first layer 11, the second layer 12, and the third layer 13 combination. When the reflection preventing layer 10″ is formed as illustrated in FIG. 4, the reflection reducing effect due to the reflection preventing layer 10 of FIGS. 2 and 3 can be obtained. Thus, the reflection preventing effect and light room contrast of a display apparatus can be dramatically increased.

Besides the shape of the reflection preventing layers 10, 10′, and 10″ illustrated in FIGS. 2 through 4, a reflection preventing layer can be formed of only a surface hardness enhancing layer, which is a hard coating layer including a hard coating material. Also, a reflection preventing layer can be a compound layer of the reflection preventing layers 10, 10′, and 10″ of FIGS. 2 through 4 and the surface hardness enhancing layer, or can be a layer in which one of the first layer 11, the second layer 12, and the third layer 13 of FIG. 2 is the surface hardness enhancing layer. Also, since a filter according to an embodiment of the present invention consists of one sheet, a process of forming a display apparatus is simple. In the filter 50 having the above structure, the transmittance with respect to visible light can be in the range of 20.0% to 90.0%. The haze of the filter 50 can be in the range of 1.0% to 15.0%.

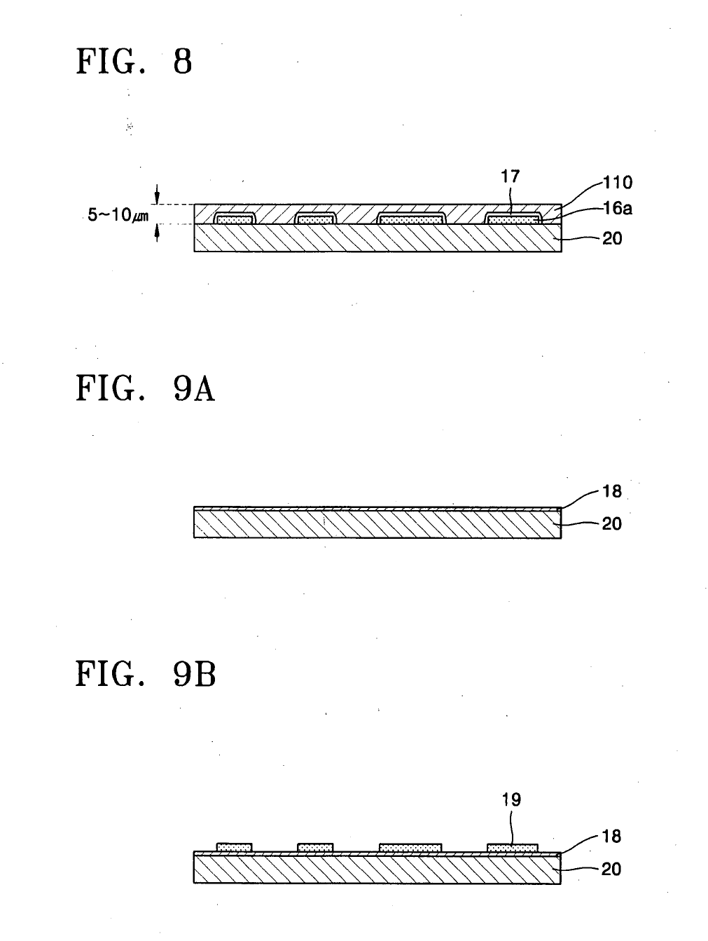

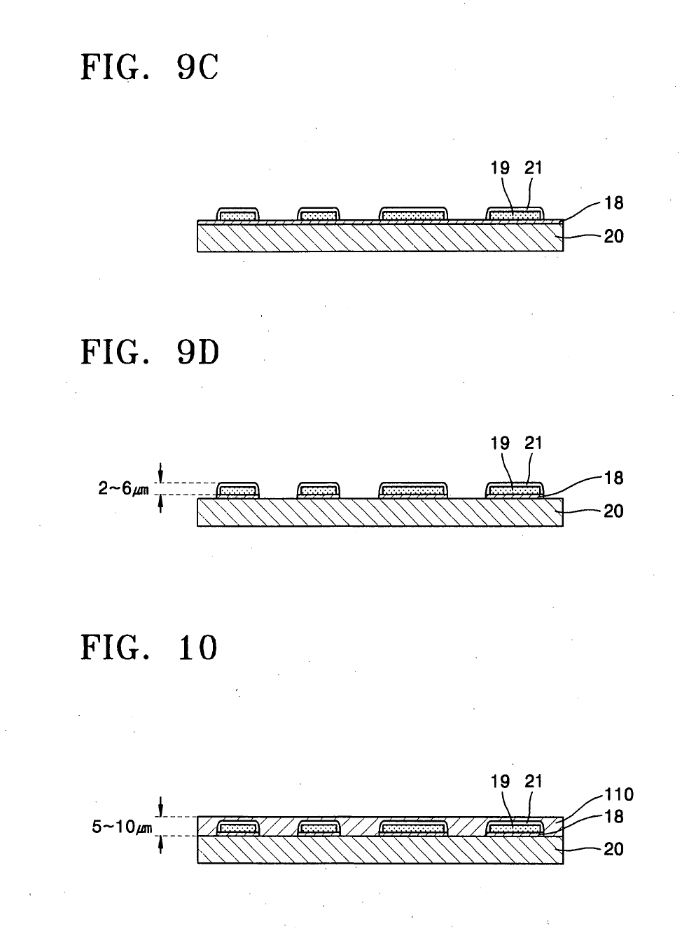

Methods of making the electromagnetic wave shielding layer 30 will now be discussed. A first method of making layer 30 will be discussed in conjunction with FIGS. 5A-6, a second method in conjunction with FIGS. 7A-8, and a third method in conjunction with FIGS. 9A-10.

A first method of manufacturing the electromagnetic wave shielding layer 30 of a mesh type by using an etching technique will now be described with reference to FIGS. 5A through 5H. An adhesive agent 3 is applied to a surface of the base film 20 (see FIG. 5A), and a thin copper film 4 is laminated thereon (see FIG. 5B). Then, a photoresist layer 5 is formed on the thin copper film 4 (see FIG. 5C), and UV is irradiated on the photoresist layer 5 by using a pattern mask that is designed with a predetermined pattern (see FIG. 5D), and then the photoresist layer 5 is developed (see FIG. 5E). In the case of a positive type photoresist, an exposed part of the photoresist layer 5 is developed. In the case of a negative type photoresist, an unexposed part of the photoresist layer 5 is developed.

Next, the thin copper film 4 on which the photoresist layer 5 is not formed is etched using an etchant (see FIG. 5F), and the photoresist layer 5 is then removed to form mesh patterns 4a made out of Cu (see FIG. 5G). However, the thin copper film 4, made out of Cu, is formed as a thick film having a thickness in the range of 10 to 12 μm, generally, and accordingly, minute unevenness is formed on a surface of the base film 20 due to the etchant when the thin copper film 4 is etched. Thus, external light is dispersed due to the unevenness, thereby causing a hazy phenomenon. Accordingly, to offset the hazy phenomenon, an agent 6, capable of preventing the dispersion, should be coated on the surface of the base film 20 as in FIG. 5H. However, the mesh patterns 4a, formed by etching the thin copper film 4, are formed in a rectangular shape. Also, there is a problem in which the agent 6 for preventing the dispersion is not sufficiently applied to a corner portion that is formed by the mesh patterns 4a and the base film 20.

Referring to FIG. 6, a reflection preventing layer 7, formed by performing a coating process once, is formed to a thickness in the range of 5.0 to 12.0 μm, generally. However, the mesh patterns 4a are formed to a thickness in the range of 10.0 to 12.0 μm, and thus it the resultant top surface is not smooth as the reflection preventing layer fails to completely fill in the spaces between the copper mesh pattern using just one coating application of the reflection preventing layer 7. To completely fill in the spaces between the mesh patterns 4a, the reflection preventing layer 7 needs to be coated twice or the mesh patterns 4a need to be etched to smooth the top surface. When the electromagnetic wave shielding layer is manufactured using the above method, the electromagnetic wave shielding layer can be formed with an exclusive size one by one due to a size characteristic of the thin copper film 4. Thus, as the size of the filter 50 varies (for example, as the size of the filter 50 increases), the manufacturing cost for setting an appropriate yield can increase.

To complement the disadvantages described above with reference to FIGS. 5A through 6, the electromagnetic wave shielding layer can be produced to have a mesh shape by using exposing and coating techniques or by using a printing technique according to embodiments of the present invention. A second method of producing the electromagnetic wave shielding layer will now be described in conjunction with FIGS. 7A through 8.

First, a photosensitive silver print layer 16, made out of, for example, AgCl or AgNO₃, is coated on the base film 20 (see FIG. 7A). UV is irradiated on the photosensitive silver print layer 16 by using a pattern mask formed in a mesh shape (see FIG. 7B). Then, the photosensitive silver print layer 16 is developed (see FIG. 7C). In the case of a positive type photoresist, a photosensitive material of an exposed part is developed, and, on the other hand, in the case of a negative type photoresist, a photosensitive material of an unexposed part is developed. In the present invention, any of the two types can be employed. The photosensitive silver print layer 16a formed in a mesh pattern is unstable, and thus can be easily oxidized. Accordingly, a Cu-coating process is performed on the photosensitive silver print layer 16a. Then, a coating film 17 is formed only on the photosensitive silver print layer 16a having a high electrical conductivity (see FIG. 7D). Both of the photosensitive silver print layer 16a and the coating film 17 can be formed to a thickness in the range of 2 to 6 μm. As illustrated in FIG. 1, to manufacture the filter 50 in which the reflection preventing layer 10 is formed as a front layer of the filter 50, the photosensitive silver print layer 16a and the coating film 17 can be covered by the reflection preventing layer 110 as illustrated in FIG. 8. That is, as illustrated in FIG. 8, the photosensitive silver print layer 16a and the coating film 17 are covered by the reflection preventing layer 110 that is formed to a thickness in the range of 5 to 12 μm by performing a coating process just once, generally. Accordingly, if the thickness of the reflection preventing layer 110 is controlled to be thin, the electromagnetic wave shielding layer 30 including the patterned photosensitive silver print layer 16a and the coating film 17 can be perfectly filled in or reclaimed by performing the coating process of layer 110 just once. In the current embodiment, since a Cu layer 17 is coated on the photosensitive silver print layer 16a as opposed to using only a Cu layer 4 as in FIGS. 5B-6, the combination of conductive layers 16a and 17 having an electromagnetic wave blocking function can be formed to be thin. Accordingly, the reflection preventing layer 110 can be coated only once, and the number of manufacturing processes can be reduced. Also, since the thin photosensitive silver print layer 16 is developed and not etched as in FIGS. 5F-5H, unevenness is not generated in the base film 20. Also, an additional process for a coating agent that offsets dispersion of light due to the unevenness is unnecessary, and accordingly, the manufacturing process is simple. Furthermore, as the size of the filter 50 varies (for example, as the size of the filter 50 increases), the manufacturing cost for setting an appropriate yield does not increase.

Now, a third method for producing the electromagnetic wave shielding layer 30 of a mesh type will be described with reference to FIGS. 9A through 9D. FIGS. 9A through 9D describe a printing technique. First, a photosensitive resin layer 18 is formed on the base film 20 (see FIG. 9A). Then, a photosensitive silver print layer 19, made out of, for example, AgCl or AgNO₃, is patterned in a mesh shape on the photosensitive resin layer 18 (see FIG. 9B). If the photosensitive silver print layer 19 is directly patterned on the base film 20, the photosensitive silver print layer 19 can be easily separated from base film 20. Thus, the photosensitive resin layer 18 is applied first.

The photosensitive silver print layer 19 that is formed in a mesh pattern is unstable, and thus can be easily oxidized. Accordingly, a Cu-coating process is performed on the photosensitive silver print layer 19. A coating film 21 is formed on only the photosensitive silver print layer 19 having a high electrical conductivity (see FIG. 9C), and a developing process is performed in order to remove unnecessary resin. Then, the photosensitive resin layer 18 formed in a part where a circuit pattern is not formed is removed (see FIG. 9D). The photosensitive silver print layer 19 and the coating film 21 can be formed to a thickness in the range of 2 to 6 μm.

As illustrated in FIG. 1, to manufacture the filter 50 in which the reflection preventing layer 10 is formed as a front layer of the filter 50, the photosensitive silver print layer 19 and the coating film 21 that are formed on the base film 20 needs to be covered by the reflection preventing layer 10. That is, as illustrated in FIG. 10, the photosensitive silver print layer 19 and the coating film 21 are covered by a reflection preventing layer 110. The reflection preventing layer 110 is applied to a thickness in the range of 5 to 12 μm by performing a coating process just once, generally. Thus, the photosensitive silver print layer 19 and the coating film 21 that function as an electromagnetic wave shielding layer can be perfectly filled in and reclaimed by performing the coating process only once.

In the current embodiment, since the Cu-coating film 21 in combination with the photosensitive silver print layer 19, as opposed to just using a copper film as in FIGS. 5F-5H as the conductive layer, the conductive layer can be formed to be thin. Accordingly, the reflection preventing layer 110 needs to only be applied once, thus reducing the number of manufacturing processes needed. Also, since a thin photosensitive silver print layer 19 is developed and not etched, unevenness is not generated in the base film 20. Also, an additional process for coating agent that offsets dispersion of light due to the unevenness is unnecessary, and accordingly, the manufacturing process is simplified. Furthermore, as the size of a filter varies (for example, as the size of a filter increases), the manufacturing cost for setting an appropriate yield does not increase.

An adhesive layer is not separately illustrated in FIGS. 5A through 10. However, when the filter 50 is attached to a surface of a display apparatus, the adhesive layer can be formed in a rear surface of base film 20 facing a front surface of the display apparatus of a filter when necessary.

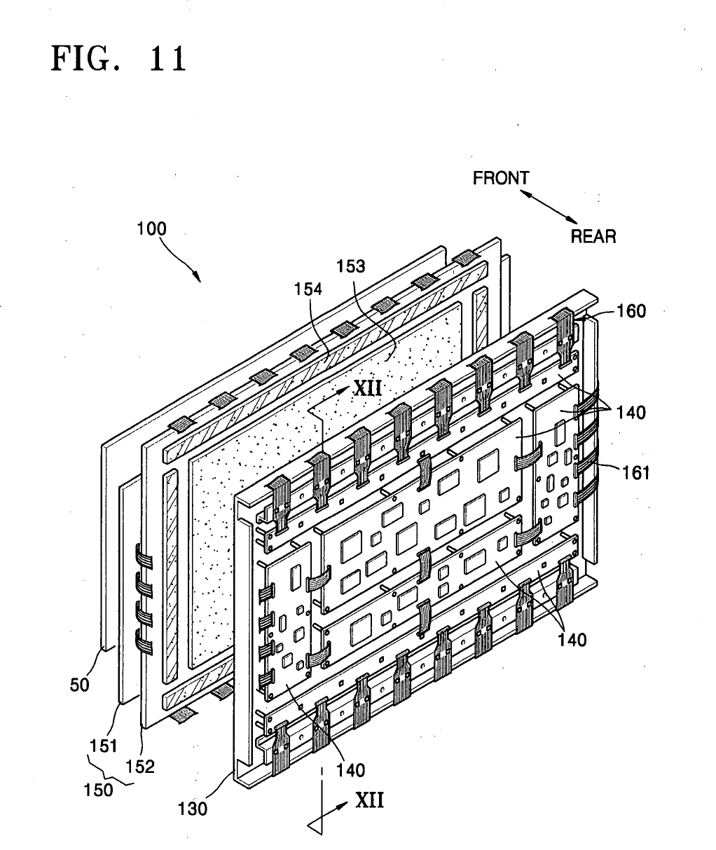

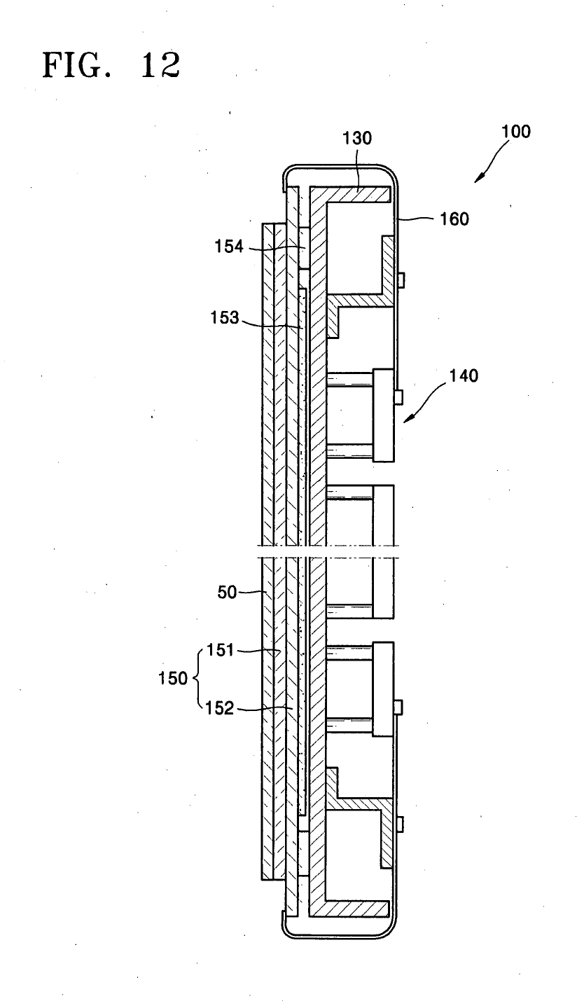

Turning now to FIGS. 11 and 12, FIG. 11 is an exploded perspective view of a plasma display apparatus 100 having the filter 50 according to an embodiment of the present invention, and FIG. 12 is a cross-sectional view taken along line XII-XII of FIG. 11. The plasma display apparatus 100 includes a plasma display panel 150, a chassis 130, and a circuit unit 140. The plasma display panel 150 displays images via gas discharge, and includes a front panel 151 and a rear panel 152 coupled together. The filter 50, according to an embodiment of the present invention, is attached to the front surface of the plasma display panel 150. An adhesive element, such as a double-sided tape 154, can be used to couple the plasma display panel 150 to the chassis 130. A thermal conduction member 153 can be located between the chassis 130 and the plasma display panel 150 to conduct heat generated by the plasma display panel 150 to the chassis 130.

The filter 50 is directly attached to an overall front surface of the plasma display panel 150 by surface contact using an adhesive layer (not shown). This description refers to the filter 50 of FIG. 1, but a filter according to an embodiment of the present invention is not limited to the filter 50 of FIG. 1 and can be of other various designs to which the present invention is applied, for example, the modification according to FIG. 2. For example, the filters having various characteristic configurations described in the embodiments of the present invention can be a filter consisting of one sheet including a reflection preventing layer, an electromagnetic wave shielding layer, and a base film as in FIG. 1, a filter including three different types of reflection preventing layers described with reference to FIGS. 2 through 4, a filter including an electromagnetic wave shielding layer made out of a silver print layer and a conductive film, or the like.

The filter 50 screens out harmful electromagnetic waves produced by the plasma display panel 150 and reduces glare. Also, infrared rays or neon glow can be blocked. Furthermore, since the filter 50 is substantially directly attached to the front surface of the plasma display panel 150, a double image problem is removed. Also, since the filter 50 consists of one sheet, the filter 50 has a lower weight than a tempered glass filter, and accordingly has a lower cost.

The chassis 130 is located on the rear of the plasma display panel 150 to structurally support the plasma display panel 150, and can be made out of plastic or a metal having high strength, such as aluminum or iron. The thermal conduction member 153 is located between the plasma display panel 150 and the chassis 130. A plurality of double-sided tape pieces 154 are located along the edges of the thermal conduction member 153, and thus, the pieces of the double-sided tape 154 adhere the plasma display panel 150 to the chassis 130.

Also, the circuit unit 140 is located on the rear of the chassis 130, and includes circuits that drive the plasma display panel 150. The circuit unit 140 transmits electrical signals to the plasma display panel 150 via signal transmitting elements. The signal transmitting element can be flexible printed cable (FPCs) 161, a tape carrier package (TCPs) 160, or a chip on film (COF). According to the present embodiment, FPCs 161 used as the signal transmitting elements are located on left and right sides of the chassis 130, and TCPs 160 used as the signal transmitting elements are located on upper and lower sides of the chassis 130.

So far, the application of a filter according to an embodiment of the present invention has been explained with reference only to a plasma display apparatus, but the filters according to the embodiments of the present invention are not limited to just plasma display apparatuses. That is, the filters according to the embodiments of the present invention can be applied to the front surface of other types of display apparatuses.

According to a filter and a plasma display apparatus having the filter according to an embodiment of the present invention, since the filter is directly attached to a front surface of a display panel, a double image can be reduced. Also, since the filter is formed by using a thin base film, the weight can be reduced and transmittance can be increased. In particular, a reflection preventing effect of external light and light room contrast can be dramatically increased. Also, since a manufacturing process is simple, the manufacturing costs can be reduced.

While the present invention has been particularly shown and described with reference to exemplary embodiments thereof, it will be understood by one of ordinary skill in the art that various changes in form and details maybe made therein without departing from the spirit and scope of the present invention as defined by the following claims.

What is claimed is:

1. A filter, comprising:
a base film;
an electromagnetic wave shielding layer arranged on a top surface of the base film; and
a reflection preventing layer arranged on a top surface of the electromagnetic wave shielding layer, the reflection preventing layer being a top layer of the filter, the filter being of only one sheet.

2. The filter of claim 1, wherein the reflection preventing layer comprises a surface hardness enhancing layer that includes a hard coating material, the reflection preventing layer being of a single layer.

3. The filter of claim 1, wherein the reflection preventing layer is an anti-reflection layer that comprises a plurality of thin film layers stacked on top of each other, a top layer of the plurality of thin film layers having a refractive index that is less than a one of the plurality of thin film layers arranged underneath and contacting the top layer.

4. The filter of claim 1, wherein the reflection preventing layer comprises an anti-glare layer having a predetermined curve arranged on a top surface thereof.

5. The filter of claim 4, the reflection preventing layer further comprising a hard coating layer arranged on the anti-glare layer.

6. The filter of claim 1, wherein a thickness of the reflection preventing layer is in the range of 5.0 to 12.0 μm, a pencil hardness of the reflection preventing layer is in the range of 1 H to 3 H, and a haze of the reflection preventing layer is in the range of 1% to 10%.

7. The filter of claim 1, wherein the electromagnetic wave shielding layer is comprised of at least one metal layer or at least one metal oxide layer.

8. The filter of claim 1, wherein the electromagnetic wave shielding layer comprises:
a patterned silver print layer; and
a Cu-coating film arranged on the patterned silver print layer.

9. The filter of claim 8, wherein the patterned silver print layer is comprised of an element selected from a group consisting of AgCl and AgNO₃.

10. The filter of claim 8, wherein the patterned silver print layer comprises a mesh shape.

11. The filter of claim 8, wherein each of the patterned silver print layer and the Cu coating film have a thickness in the range of 2 to 6 μm.

12. The filter of claim 8, wherein the patterned silver print layer is produced by a photo etching process.

13. The filter of claim 8, wherein the patterned silver print layer is produced by a process comprising:
coating a photosensitive resin layer on the base film; and
performing a printing process on the photosensitive resin layer.

14. The filter of claim 1, wherein the base film comprises an element selected from a group consisting of polyethersulphone, polyacrylate, polyetherimide, polyethyelenen napthalate, polyethyeleneterepthalate (PET), polyphenylene sulfide, polyallylate, polyimide, polycarbonate, cellulous triacetate, cellulose acetate propinonate and a combination thereof.

15. The filter of claim 1, wherein a light transmittance with respect to visible light of the filter is in the range of 20% to 90%, and a haze is in the range of 1% to 15%.

16. A display apparatus, comprising the filter of claim 1 the filter being directly attached to a front surface of the display apparatus.

17. The display apparatus of claim 16, wherein a light transmittance with respect to visible light of the filter is in the range of 20% to 90%, and an entire haze is in the range of 1% to 15%.

18. The display apparatus of claim 15, further comprising an adhesive layer arranged on a rear side of the base film, the adhesive layer to adhere the filter to the front surface of the display apparatus.

19. The display apparatus of claim 18, wherein the adhesive layer comprises one element selected from a group consisting of acrylic resin, polyester resin, epoxy resin, urethane resin, and pressure sensitive adhesive (PSA).

20. The display apparatus of claim 18, wherein the adhesive layer comprises at least one of a dye and a pigment to perform color correction, neon glow blocking, or near infrared ray blocking.
